(19) United States
(12) Patent Application Publication
(10) Pub. No.: US 2023/0339323 A1
(43) Pub. Date: Oct. 26, 2023

(54) DISPLAY CONTROL APPARATUS, DISPLAY CONTROL SYSTEM, AND DISPLAY CONTROL METHOD

(71) Applicant: Panasonic Intellectual Property Management Co., Ltd., Osaka (JP)

(72) Inventors: Tadahiro UCHIKOSHI, Kanagawa (JP); Hiroshi ANDO, Kanagawa (JP); Hiroshi IKEDA, Tokyo (JP); Shintaro TSUBATA, Kanagawa (JP); Masahito OISHI, Kanagawa (JP)

(73) Assignee: Panasonic Intellectual Property Management Co., Ltd., Osaka (JP)

(21) Appl. No.: 18/209,209

(22) Filed: Jun. 13, 2023

Related U.S. Application Data
(63) Continuation of application No. PCT/JP2021/036753, filed on Oct. 5, 2021.

(30) Foreign Application Priority Data
Dec. 16, 2020 (JP) 2020-208423

(51) Int. Cl. B60K 35/00; B60W 50/16; G06V 20/59

(52) U.S. Cl. CPC B60K 35/00; B60W 50/16; G06V 20/597; B60K 2370/149; B60K 2370/152; B60K 2370/178; B60K 2370/194; B60K 2370/52; B60K 2370/566; B60W 2050/143

(57) ABSTRACT

A display control apparatus includes: a first selector that, when line-of-sight information indicating a direction in which a line of sight of an occupant of a vehicle is directed is outputted, selects one of a plurality of display apparatuses as a display apparatus for displaying information provided to the occupant of the vehicle, the plurality of display apparatuses being configured to display the information, the one display apparatus existing in the direction in which the line of sight is directed; and a second selector that, when the line-of-sight information is not outputted, selects, as the display apparatus for displaying the information, one of the plurality of display apparatuses to which the line of sight of the occupant is more likely to be directed than to other display apparatuses.

### TECHNICAL FIELD

The present disclosure relates to a display control apparatus, a display control system, and a display control method.

### BACKGROUND ART

Patent Literature (hereinafter, referred to as “PTL”) 1 discloses a technique of selecting, from among a plurality of display apparatuses mounted in a vehicle, a display apparatus to which a driver's line of sight is directed, and displaying, on a screen of the selected display apparatus, information necessary for driving.

The display control apparatus disclosed in PTL 1 includes a line-of-sight detection means that, based on a face image of the driver captured by an imager, detects a direction in which the driver's line of sight is directed, and a selection means that selects, as a display apparatus on which the information necessary for driving is to be displayed, one of a plurality of display apparatuses to which the driver directs the line of sight, based on line-of-sight information indicating the direction in which the line of sight is directed.

According to the above-described display control apparatus, the information necessary for driving is displayed on the display apparatus to which the driver directs the line of sight. It is thus possible to confirm the information necessary for driving while grasping a situation around the vehicle in the directed line of sight.

### CITATION LIST

### Patent Literature

PTL 1 Japanese Patent Application Laid-Open No. 2007-249567

### SUMMARY OF INVENTION

One non-limiting and exemplary embodiment of the present disclosure facilitates providing a display control apparatus, a display control system, and a display control method for displaying information necessary for safe driving on a display apparatus to which a line of sight can be directed, even when no line of sight is detectable.

A display control apparatus according to one exemplary embodiment of the present disclosure includes: a first selector that, when line-of-sight information indicating a direction in which a line of sight of an occupant of a vehicle is directed is outputted, selects one of a plurality of display apparatuses as a display apparatus for displaying the information provided to the occupant of the vehicle, the plurality of display apparatuses being configured to display the information, the one display apparatus existing in the direction in which the line of sight is directed; and a second selector that, when the line-of-sight information is not outputted, selects, as the display apparatus for displaying the information, one of the plurality of display apparatuses to which the line of sight of the occupant is more likely to be directed than to other display apparatuses.

A display control system according to one exemplary embodiment of the present disclosure includes the above-described display control apparatus and the display apparatus.

A display control method according to one exemplary embodiment of the present disclosure includes: a detecting step of detecting a line of sight of an occupant of a vehicle by using an imager; a line-of-sight information outputting step of outputting line-of-sight information indicating a direction in which the line of sight is directed; a first selecting step of selecting one of a plurality of display apparatuses as a display apparatus for displaying information provided to the occupant of the vehicle, when the line-of-sight information is outputted, the plurality of display apparatuses being configured to display the information, the one display apparatus existing in the direction in which the line of sight is directed; and a second selecting step of selecting, as the display apparatus for displaying the information, one of the plurality of display apparatuses to which the line of sight of the occupant is more likely to be directed than to other display apparatuses, when the line-of-sight information is not outputted.

### Advantageous Effects of Invention

According to the disclosed exemplary embodiments, it is possible to provide a display control apparatus, a display control system, and a display control method for displaying information necessary for safe driving on a display apparatus to which a line of sight can be directed, even when no line of sight is detectable.

Additional benefits and advantages of the disclosed exemplary embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates a configuration example of display control system 100 according to an embodiment of the present disclosure;

FIG. 2 is a flowchart for explaining operation of display control system 100 according to an embodiment of the present disclosure;

FIG. 3A is a flowchart for explaining a display position selection process;

FIG. 3B is a flowchart for explaining the display position selection process; and

FIG. 4 illustrates an example of hardware configuration of display control system 100 according to an embodiment of the present disclosure.

### DESCRIPTION OF EMBODIMENTS

Hereinafter, preferred embodiments of the present disclosure will be described in detail with reference to the appended drawings. Note that, in the present specification and drawings, components having substantially the same functions are provided with the same reference symbols, and redundant description will be omitted.

### EMBODIMENT

To begin with, the background that led to creation of embodiments according to the present disclosure will be described.

For example, in a known technique described in PTL 1 or the like, when line-of-sight information indicating a direction in which a driver's line of sight detected based on an image of a driver's face captured by an imager is directed is outputted, information necessary for driving is displayed on one of a plurality of display apparatuses to which the driver directs the line of sight.

However, when the line of sight cannot be detected due to fogging of the imager for detecting the line of sight, or when the line of sight cannot be detected due to a bug occurring in software of a line-of-sight detection means, the line-of-sight information indicating the direction in which the line of sight of a vehicle occupant is directed is not outputted. Accordingly, the information necessary for driving cannot be displayed on the display apparatus to which the line of sight is directed, and there is a possibility of a decrease in safety of driving.

In view of the above, suppressing the decrease in the safety of driving even when the line-of-sight information is not outputted is demanded. Hereinafter, embodiments according to the present disclosure will be described.

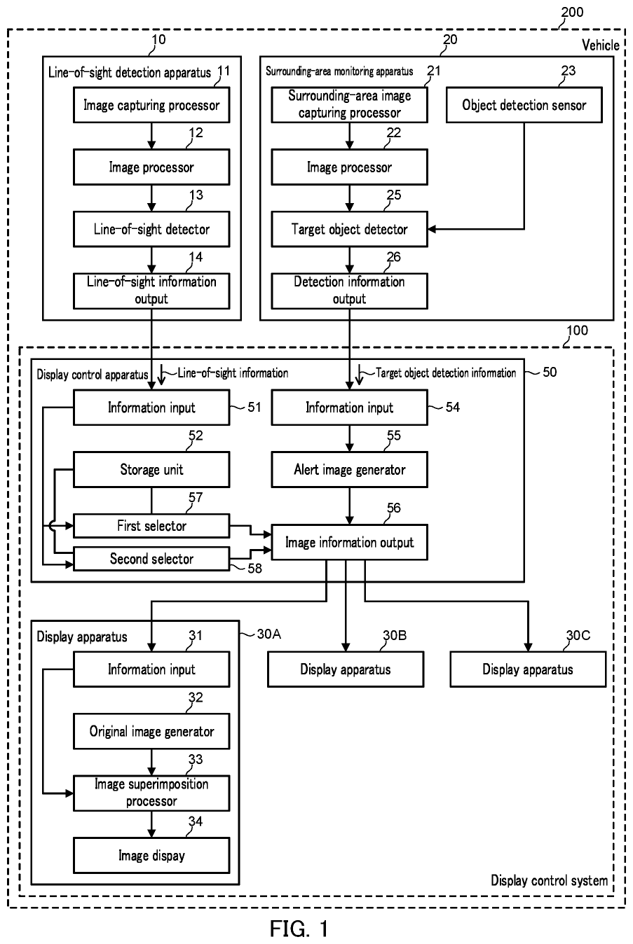

FIG. 1 illustrates a configuration example of display control system 100 according to an embodiment of the present disclosure. Vehicle 200 illustrated in FIG. 1 includes display control system 100, line-of-sight detection apparatus 10 that sequentially detects a line of sight of an occupant of vehicle 200, and surrounding-area monitoring apparatus 20 that monitors an object existing in the surrounding area of the vehicle.

The vehicle occupant is a driver, a passenger, or the like of vehicle 200. Vehicle 200 is a passenger car, a freight car, a shared car, or the like. In the embodiment of the present disclosure, a configuration example of display control system 100 that detects the line of sight of the driver of vehicle 200 will be described.

(Display Control System 100)

Display control system 100 includes a plurality of display apparatuses 30A to 30C and display control apparatus 50. Hereinafter, the plurality of display apparatuses 30A to 30C are referred to as “display apparatuses 30” when they are not distinguished from one another.

(Line-of-Sight Detection Apparatus 10)

Line-of-sight detection apparatus 10 is an apparatus that detects a line-of-sight direction of a driver of vehicle 200 and outputs line-of-sight information indicating a direction in which the line of sight of the driver is directed.

Line-of-sight detection apparatus 10 includes image capturing processor 11, image processor 12, line-of-sight detector 13, and line-of-sight information output 14.

(Image Capturing Processor 11)

Image capturing processor 11 is a camera or the like that captures an image of the inside of the vehicle. Image capturing processor 11 includes an imaging element such as a Charge Coupled Device (CCD) or a Complementary Metal Oxide Semiconductor (CMOS).

Image capturing processor 11 is disposed at a position where an image of the driver's face can be captured, captures an image including the driver's face, and sequentially outputs data of the captured image (hereinafter, referred to as image data) to image processor 12.

The position where an image of the driver's face can be captured is, for example, a dashboard of vehicle 200, an instrument panel of the driver's seat, a ceiling of vehicle 200, or the like.

Note that the number of image capturing processors 11 is not limited to one, and a plurality of image capturing processors may be disposed in the vehicle.

(Image Processor 12)

When the image data is inputted, image processor 12 binarizes the image captured by image capturing processor 11 to obtain a binary image. Image processor 12 inputs data of the binary image (hereinafter, referred to as “binary image data”) to line-of-sight detector 13.

(Line-of-Sight Detector 13)

Line-of-sight detector 13 detects a line of sight based on the binary image data. For example, line-of-sight detector 13 identifies an eyeball region of the driver by analyzing the binary image data, and obtains the eyeball center coordinates from the curvature of the eyeball shape.

Further, line-of-sight detector 13 identifies an iris (pupil) region from the eyeball region to obtain iris center coordinates, and determines a direction from the above-described eyeball center coordinates toward the iris center coordinates as a line-of-sight direction.

Further, by using an eyeball center position as a starting point, line-of-sight detector 13 identifies, as the line of sight, a straight line extending from the start point in the line-of-sight direction, and transmits line-of-sight information, which is information indicating the identified line of sight, to line-of-sight information output 14.

(Line-of-Sight Information Output 14)

Line-of-sight information output 14 outputs, to information input 51 of display control apparatus 50, the line-of-sight information transmitted from line-of-sight detector 13. Details of the configuration of information input 51 will be described later.

(Surrounding-Area Monitoring Apparatus 20)

Surrounding-area monitoring apparatus 20 is an apparatus for detecting an object existing in the surrounding area of the vehicle.

Surrounding-area monitoring apparatus 20 includes surrounding-area image capturing processor 21, image processor 22, object detection sensor 23, target object detector 25, and detection information output 26.

(Surrounding-Area Image Capturing Processor 21)

Surrounding-area image capturing processor 21 is an omnidirectional camera, a panoramic camera, or the like that captures an image of the surroundings of the vehicle. Hereinafter, the image of the surroundings of the vehicle is referred to as “surrounding-area image.” Like image capturing processor 11 of line-of-sight detection apparatus 10, surrounding-area image capturing processor 21 includes an image sensor such as a CCD or CMOS.

The surrounding-area image is, for example, an image of a landscape in front of vehicle 200, a landscape on a lateral side of vehicle 200, a landscape in the rear of vehicle 200, and the like. Examples of the landscapes include an object existing on a roadway on which vehicle 200 is traveling. Examples of the object existing on the roadway include automobiles, buildings, structures (advertisements, road signs, traffic lights, utility poles, etc.), humans, animals, and the like.

Surrounding-area image capturing processor 21 is disposed, for example, at a position where an image of the landscape outside the vehicle can be captured. The position is at a front grille, a side mirror, a ceiling, a rear bumper, or the like. Surrounding-area image capturing processor 21 inputs data of the captured surrounding-area image (hereinafter, referred to as “surrounding-area image data”) to image processor 22.

(Image Processor 22)

Image processor 22 performs image processing for detecting a detection target object from among objects existing in the surrounding area of vehicle 200 based on the surrounding-area image data. Hereinafter, a preset detection target object is referred to as the “target object.”

Examples of the target object include a passenger car, a motorcycle, a bus, a taxi, a bicycle, a pedestrian, and an animal. The image processing is, for example, edge detection processing. Image processor 22 inputs an image of the target object to target object detector 25.

(Object Detection Sensor 23)

Object detection sensor 23 is a sensor for detecting a position of an object existing in the surrounding area of the vehicle, and is, for example, a sonar.

The sonar emits, for example, a pulsed sound wave having a constant frequency. When the pulsed sound wave hits an object or the like in the surrounding area of the vehicle, a part of the pulsed sound wave is reflected and returns to the sonar. The longer the distance from the vehicle to the object, the longer the time taken until the part of the pulsed sound wave returns to the sonar after the emission of the pulsed sound wave from the sonar.

Using this relationship, the sonar estimates the distance to the object by measuring the round-trip time taken until an echo reflected by the object returns to the sonar after the emission of the pulsed sound wave, and detects the position of the object with reference to the vehicle based on the estimated distance.

Further, object detection sensor 23 inputs object position information, which is information indicating the position of the detected object, to target object detector 25.

(Target Object Detector 25)

Target object detector 25 performs, for example, the following determination based on the image and the object position information of a target.
(1) Target object detector 25 determines that there is no collision risk, for example, when a rear end of a preceding vehicle, which is a detection target, is present in front of the vehicle and the distance from this rear end to a front end of the vehicle is equal to or greater than a predetermined value (for example, several meters to several tens of meters) that changes in accordance with the relative speed.
(2) Target object detector 25 determines that there is a collision risk, for example, when the rear end of the preceding vehicle, which is a detection target, is present in front of the vehicle and the distance from this rear end to the front end of the vehicle is less than the predetermined value.

In this way, target object detector 25 detects a target object that might collide with the vehicle, generates target object detection information that is information indicating detection of the target object that might collide with the vehicle, and transmits the target object detection information to detection information output 26.

Detection information output 26 outputs the target object detection information transmitted from target object detector 25 to information input 54 of display control apparatus 50. Details of the configuration of information input 54 will be described later.

(Display Control Apparatus 50)

Display control apparatus 50 is an apparatus that generates an alert image provided to a vehicle occupant based on the line-of-sight information and the target object detection information, and transmits the generated alert image to display apparatus 30.

The alert image is one example of information necessary for driving. The alert image is, for example, an image for alerting the vehicle occupant that a target object that may collide with vehicle 200 exists in the surrounding area of the vehicle. The alert image is produced based on, for example, the target object detection information transmitted from surrounding-area monitoring apparatus 20.

The alert image may be a symbol such as “!” or a character such as “collision danger” that can alert the vehicle occupant. Further, the alert image may be a combination thereof.

Display control apparatus 50 includes information input 51, storage unit 52, first selector 57, information input 54, alert image generator 55, image information output 56, first selector 57, and second selector 58.

(Information Input 51)

The line-of-sight information transmitted from line-of-sight information output 14 is inputted to information input 51, and information input 51 transfers the line-of-sight information to first selector 57 and second selector 58.

(Storage unit 52) Storage unit 52 stores, for example, coordinate data, an identification ID (Identifier) of display apparatus 30, a line-of-sight detection history, an information display history, and the like. Details of these pieces of information will be described later.

(First Selector 57)

For example, when the line-of-sight information is outputted from line-of-sight information output 14 at a predetermined cycle, first selector 57 determines that line-of-sight detection apparatus 10 normally detects the line of sight of the driver.

In this case, first selector 57 selects, as the display apparatus that displays the alert image, one of a plurality of display apparatuses 30 which exists in the direction toward which the line of sight is directed.

Specifically, first selector 57 reads the coordinate data stored in storage unit 52, and identifies display apparatus 30 existing in the line of sight of the driver with reference to the front side of an in-vehicle meter panel as a reference position. The coordinate data is data representing a position of each of the display surfaces of the plurality of display apparatuses in the vehicle.

First selector 57 selects identified display apparatus 30 as a display apparatus for displaying the alert image.

First selector 57 reads the identification ID corresponding to selected display apparatus 30 from, for example, storage unit 52, and transmits it to image information output 56. Details of the configuration of image information output 56 will be described later.

(Second Selector 58)

For example, when the line-of-sight information is not outputted from line-of-sight information output 14 at a predetermined cycle, second selector 58 determines that line-of-sight detection apparatus 10 is incapable of normally detecting the line of sight of the driver.

The state in which the line of sight cannot be normally detected is, for example, a state in which the line of sight of the driver cannot be detected due to fogging of the lens of image capturing processor 11, a state in which the line of sight of the driver cannot be detected due to a bug occurring in software for controlling line-of-sight detection apparatus 10, a state in which the line of sight is blocked by eyeglasses or the like, or so forth.

As described above, in a case where the line-of-sight information is not outputted from line-of-sight information output 14, the alert image, which is the information necessary for driving, cannot be displayed on display apparatus 30 toward which the line of sight of the driver is directed, and there is a possibility of a decrease in the safety of driving.

As a countermeasure against this problem, display control apparatus 50 according to the embodiment of the present disclosure is configured to estimate, based on the below-described history information, display apparatus 30 of the plurality of display apparatuses to which the line of sight of the vehicle occupant is more likely to be directed than to the other display apparatuses, and cause estimated display apparatus 30 to display an alert image.

Specifically, based on the history information, second selector 58 selects, as a display apparatus for displaying the alert image, a display apparatus from among the plurality of display apparatuses 30 to which the line of sight of the vehicle occupant is more likely to be directed than to the other display apparatuses, and causes selected display apparatus 30 to display the alert image.

The history information includes, for example, a line-of-sight detection history, an information display history, and the like.

The following information can be presented as examples of the line-of-sight detection history.
(1) The cumulative time when the line of sight has been directed to display apparatus selected by first selector 57 in the past.
(2) The number of times the line of sight has been directed to display apparatus 30 selected by first selector 57 in the past.
(3) Information indicating display apparatus 30 to which the line of sight has been directed at the latest time among display apparatuses 30 selected by first selector 57 in the past.

The following information can be presented as examples of the information display history.
(1) The cumulative time when the alert image has been displayed on display apparatus selected by first selector 57 in the past.
(2) The number of display times the alert image has been displayed on display apparatus 30 selected by first selector 57 in the past.
(3) Information indicating display apparatus 30 on which the alert image has been displayed at the latest time among display apparatuses 30 selected by first selector 57 in the past.

These pieces of history information may be set in advance in second selector 58 or may be stored in storage unit 52.

(Information Input 54)

The target object detection information outputted from detection information output 26 is inputted to information input 54, and information input 54 transfers the target object detection information to alert image generator 55.

(Alert Image Generator 55)

Alert image generator 55 generates the above-described alert image based on the target object detection information, and inputs the generated alert image to image information output 56.

(Image Information Output 56)

Image information output 56 outputs the alert image created by alert image generator 55 to display apparatus 30 selected by first selector 57 or second selector 58.

Specifically, upon receiving the identification ID of display apparatus 30 transmitted from first selector 57 or second selector 58, image information output 56 identifies display apparatus 30 corresponding to the identification ID with reference to table information set in storage unit 52 or image information output 56.

Then, image information output 56 outputs, to identified display apparatus 30, the alert image created by alert image generator 55 to identified display apparatus 30.

(Display Apparatus 30)

Display apparatus 30A includes information input 31, original image generator 32, image superimposition processor 33, and image display apparatus 34. Display apparatus 30A is, for example, a center display disposed on a vehicle interior.

Display apparatus 30B is configured similarly to display apparatus 30A. Display apparatus 30B is, for example, an in-vehicle meter panel disposed in front of the driver's seat.

Display apparatus 30C is configured similarly to display apparatus 30A. Display apparatus 30C is, for example, a head-up display.

Note that the types of display apparatuses 30 disposed in vehicle 200 are not limited to these, and may include, for example, an electronic mirror (for example, an electronic room mirror, an electronic side mirror, or the like) in which an in-vehicle camera and a display are combined.

The number of display apparatuses 30 disposed in vehicle 200 is not limited to three, and may be two, four, or more.

(Information Input 31)

The alert image outputted by image information output 56 is inputted to information input 31, and information input 31 transfers the alert image to image superimposition processor 33.

(Original Image Generator 32)

Original image generator 32 generates original image data and inputs the original image data to image superimposition processor 33. The original image data is data of an image (original image) displayed on image display apparatus 34 when a target object with which the vehicle may collide does not exist in the surrounding area of the vehicle.

Specifically, the original image displayed on image display apparatus 34 of display apparatus 30A is, for example, a map displayed on a navigational screen, an image for operating an audio device, or the like.

The original image displayed on image display apparatus 34 of display apparatus 30B is an image of, for example, a speedometer, a hydraulic pressure gauge, a fuel-remaining-amount gauge, or the like.

The original image displayed on image display apparatus 34 of display apparatus 30C is, for example, an image indicating the vehicle speed, an image indicating the vehicle traveling direction, or the like.

(Image Superimposition Processor 33)

Based on the original image and the alert image, image superimposition processor 33 generates superimposed image data representing an image in which the alert image is superimposed on the original image, and inputs the superimposed image data to image display apparatus 34.

(Image Display Apparatus 34)

Image display apparatus 34 generates a superimposed image based on the superimposed image data, and displays the superimposed image on the screen of image display apparatus 34.

Thus, for example, in the case where the distance between the vehicle and the preceding vehicle is narrowed while the driver is gazing at the in-vehicle meter panel of traveling vehicle 200, the alert image is superimposed on the original image on the in-vehicle meter panel toward which the line of sight of the driver is directed.

Therefore, even when the line of sight is not directed forward, it is possible to promptly notify the driver that vehicle 200 is in a situation where the vehicle may collide with an object in the surrounding area of the vehicle. Accordingly, the driver can take a collision avoidance action such as sudden braking.

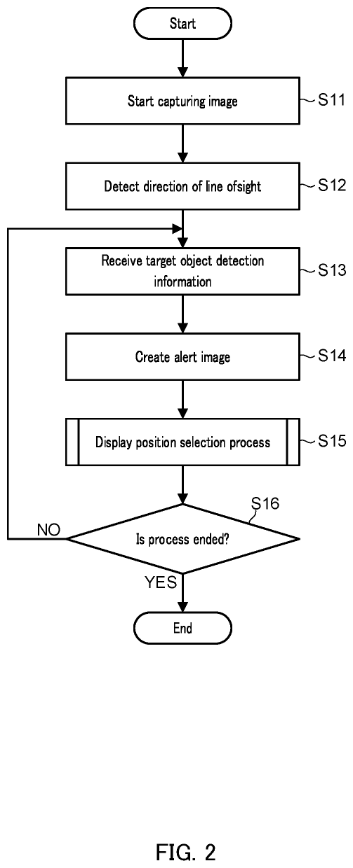

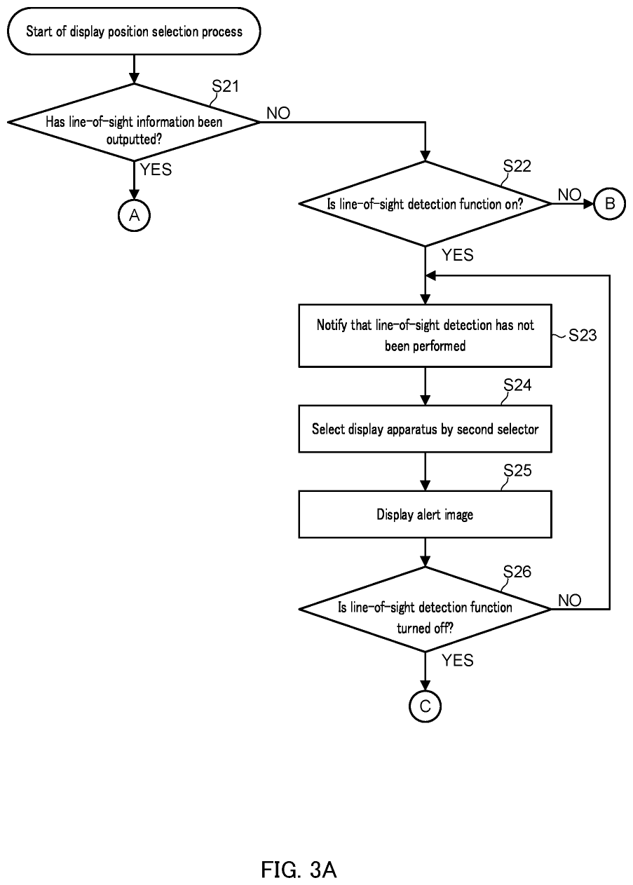

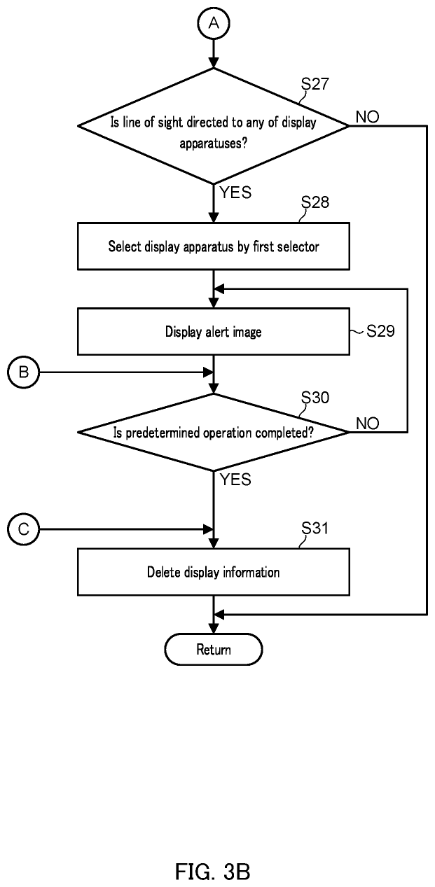

Referring now to FIGS. 2, 3A, and 3B, the operation of display control system 100 will be described.

FIG. 2 is a flowchart for explaining the operation of display control system 100 according to the embodiment of the present disclosure.

Image capturing processor 11 starts capturing an image of the driver's face (step S11). The captured image is transmitted to line-of-sight detector 13 via image processor 12.

After the process of step S11, line-of-sight detector 13 detects the direction in which the driver's line-of-sight is directed based on the received image (step S12).

The line-of-sight information, which is the detection result of detection of the line of sight, is transmitted to first selector 57 and second selector 58 via line-of-sight information output 14 and information input 51. Processing of first selector 57 and second selector 58 will be described later.

In conjunction with the processing of step S12, information input 54 receives the target object detection information transmitted by detection information output 26, and transmits the target object detection information to alert image generator 55 (step S13).

After the process of step S13, alert image generator 55 creates an alert image based on the target object detection information (step S14).

After the process of step S14, alert image generator 55 transmits the created alert image to image information output 56. Thereafter, a display position selection process illustrated in step S15 is executed.

Referring to FIGS. 3A and 3B, the display position selection process illustrated in step S15 will be described.

FIGS. 3A and 3B are flowcharts for explaining the display position selection process.

Display control apparatus 50 determines whether or not line-of-sight information has been outputted (step S21).

When the line-of-sight information has not been outputted (step S21: NO), the process of step S22 is executed.

In step S22, a process of determining whether a line-of-sight detection function has been activated or the line-of-sight detection function has been stopped by an operation by a driver or the like is executed.

Specifically, in above-described step S21, when the line-of-sight information has not been outputted, display control apparatus 50 determines whether the line-of-sight detection function by line-of-sight detection apparatus 10 is in an on state or an off state (step S22).

The on state is a state in which the line-of-sight detection function of line-of-sight detection apparatus 10 has been activated, and the off state is a state in which the line-of-sight detection function of line-of-sight detection apparatus 10 has been stopped.

The driver can select whether the line-of-sight detection function is on or off. For example, when the line-of-sight detection function is set to “ON,” a signal indicating the state in which the line-of-sight detection function has been activated is transmitted from line-of-sight detection apparatus 10 to display control apparatus 50.

When the line-of-sight detection function is set to “OFF,” a signal indicating the state in which the line-of-sight detection function has been stopped is transmitted from line-of-sight detection apparatus 10 to display control apparatus 50.

Display control apparatus 50 is capable of determining based on these signals whether the line-of-sight detection function has been activated or the line-of-sight detection function has been stopped by an operation by a driver or the like.

When the line-of-sight detection function of line-of-sight detection apparatus 10 is off (step S22: NO), display control apparatus 50 determines that the line-of-sight information has not been outputted because the line-of-sight detection function has been turned off by the driver. In this case, the process of step S30 is executed, and displaying the alert image is continued. The process of step S30 will be described later.

When the line-of-sight detection function of line-of-sight detection apparatus 10 is in the on state (step S22: YES), display control apparatus 50 determines that the line-of-sight information has not been outputted because the line-of-sight cannot be normally detected.

In this case, the driver is notified that the line-of-sight detection is not performed although the line-of-sight detection function is in the on state (step S23).

As the notification method, for example, a message such as “no line of sight has been detected” may be displayed on display apparatus 30, or a voice may be reproduced from a speaker in the vehicle.

In addition, the notification method may be to blink a lamp inside the vehicle or to vibrate a steering, a seat, or the like.

At this time, display apparatus 30 may display a message for prompting the driver to confirm whether the camera is fogging, a message for prompting the driver to confirm whether the face is covered with a mask or the like, or other messages.

After step S23, second selector 58 selects display apparatus 30 (step S24). As a result, the alert image is displayed on selected display apparatus 30 (step S25).

Note that the processes of step S24 and step S25 may be executed after the completion of the process of step S21 and before the process of step S22 is started.

After the process of step S25, display control apparatus 50 determines whether or not an operation for turning off the line-of-sight detection function has been performed (step S26).

For example, display control apparatus 50 causes display apparatus 30 to display a message “Do you want to set the line-of-sight detection function to the off state?” and notifies the driver that the line-of-sight detection function is turned off after the line-of-sight detection function is turned off (step S26: YES). Then, display control apparatus 50 executes processes of step S31 onward.

In addition, when the operation of turning off the line-of-sight detection function is not performed even though display apparatus 30 is caused to display the message (step S26: NO), display control apparatus 50 repeats the processes of step S23 onward.

Note that display control apparatus 50 may automatically or manually restart line-of-sight detection apparatus 10, for example, instead of the process of step S26.

By restarting line-of-sight detection apparatus 10, the software may operate normally, and the line of sight may be detectable.

When the line-of-sight information cannot be obtained even when line-of-sight detection apparatus 10 is restarted, display control apparatus 50 generates a message notifying the driver of the fact and displays the message on display apparatus 30. It is thus possible to notify the driver that it is difficult to detect the line of sight even when the apparatus is restarted.

Note that display control apparatus 50 may forcibly turn off the line-of-sight detection function after notifying the driver that the line-of-sight cannot be detected even after the restart.

The process returns to step S21, and when the line-of-sight information has been outputted (step S21: YES), the process of step S27 is executed.

When the line-of-sight information has been outputted in step S21, display control apparatus 50 determines whether the line of sight is directed to any of the plurality of display apparatuses 30 (step S27).

When the line of sight is directed to any one of the plurality of display apparatuses (step S27: YES), first selector 57 executes the process of step S28.

First selector 57 selects display apparatus 30 to which the line of sight is directed (step S28).

When display apparatus 30 is selected in step S28, image information output 56 transmits an alert image to selected display apparatus 30. Accordingly, the alert image is displayed in such a manner as to be superimposed on the original image displayed on display apparatus 30 to which the line of sight is directed (step S29).

Thereafter, display control apparatus 50 determines, for example, whether or not the operation corresponding to the alert image displayed on display apparatus 30 by the driver has been completed (step S30).

For example, when a failure avoidance operation is performed after a message “collision caution” is displayed on the head-up display, display control apparatus 50 determines whether or not the collision avoidance operation has been completed, based on the rotation direction of a steering wheel, the rotation amount of the steering wheel, the depression amount of a brake pedal, the depression amount of an accelerator pedal, and the like.

When the collision avoidance operation has not been completed (step S30: NO), display control apparatus 50 repeats the processes of step S29 onward.

When the collision avoidance operation has been completed (step S30: YES), display control apparatus 50 determines that the operation corresponding to the alert image has been completed, and deletes the alert image (step S31).

Note that the process of step S31 is not limited to this, and may be the following process.

For example, after displaying a confirmation message “Have you avoided collision?” on a touch panel-type center display and when the driver touches the confirmation message, display control apparatus 50 may determine that the operation corresponding to the alert image has been completed and delete the alert image.

The process returns to step S27, and when the line of sight is not directed to any of the plurality of display apparatuses 30 (step S27: NO), the process of step S16 illustrated in FIG. 2 is executed.

In step S16 illustrated in FIG. 2, when the processes up to step S15 have not been completed (step S16: NO), display control apparatus 50 repeats the processes of step S13 onward.

In step S16 illustrated in FIG. 2, when the processes up to step S15 have been completed (step S16: YES), display control apparatus 50 ends the series of processes.

First selector 57 may be configured such that, in a case where the line of sight is not directed to any of the plurality of display apparatuses 30, first selector 57 identifies display apparatus 30 existing at the position closest to the line of sight as display apparatus existing in the direction in which the line of sight of the driver is directed.

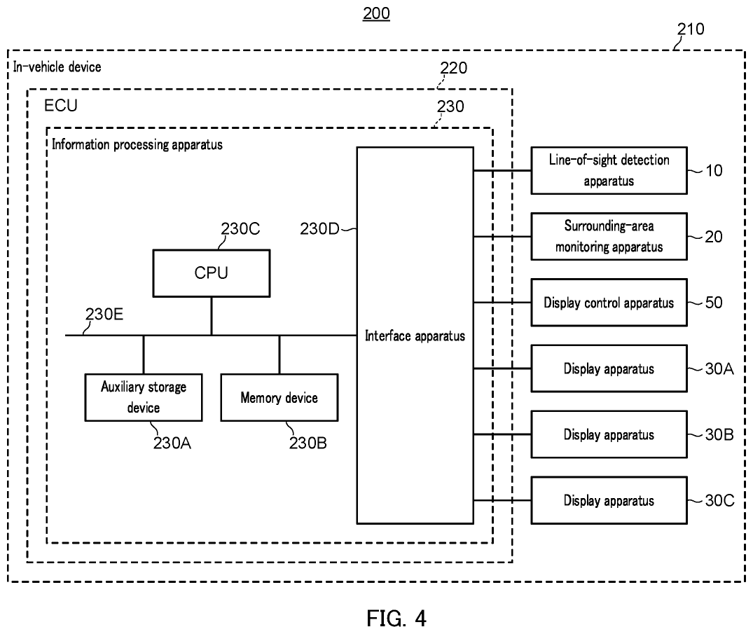

Next, an exemplary hardware configuration of display control system 100 will be described with reference to FIG. 4. FIG. 4 illustrates an exemplary hardware configuration of display control system 100 according to the embodiment of the present disclosure.

Vehicle 200 includes, as in-vehicle devices 210, line-of-sight detection apparatus 10, surrounding-area monitoring apparatus 20, display control apparatus 50, display apparatus 30A, display apparatus 30B, display apparatus 30C, and ECU 220.

ECU 220 includes auxiliary storage device 230A, Memory device 230B, CPU 230C, and interface apparatus 230D. These apparatuses constitute information processing apparatus 230 and are connected to one another by bus line 230E.

Auxiliary storage device 230A is a Hard Disk Drive (HDD), a flash memory, or the like that stores files and data required for the processes of ECU 220. Memory device 230B reads and stores a program from auxiliary storage device 230A when an instruction to start the program is given.

CPU 230C executes a program stored in Memory device 230B, and implements various functions of ECU 220 in accordance with the program.

Interface apparatus 230D is, for example, an interface that connects CPU 230C to line-of-sight detection apparatus 10, surrounding-area monitoring apparatus 20, and the like.

Note that, the present embodiment has been described in relation to a configuration example in which the alert image is generated using the target object detection information outputted from surrounding-area monitoring apparatus 20, but the alert image may be generated using vehicle information obtained from various sensors provided in vehicle 200.

The vehicle information is, for example, door opening/closing state information, tire air pressure information, engine water temperature information, travelable distance information, and the like.

The alert image created based on the door opening/closing state information is, for example, a message “the door is open.”

When the door is closed after such a message is displayed on display apparatus 30, display control apparatus 50 determines that the operation corresponding to the alert image has been completed in the above-described process of step S30, and deletes the alert image in the above-described process of step S31.

The alert image created based on the air pressure information of the tire is, for example, a message “the air pressure exceeds the proper range” or a message “the air pressure is low.”

When the air pressure is adjusted to a proper value after such a message is displayed on display apparatus 30, display control apparatus 50 determines that the operation corresponding to the alert image has been completed in the above-described process of step S30, and deletes the alert image in the above-described process of step S31.

The alert image created based on the water temperature information of the engine is, for example, a message “overheating can be caused.”

When the engine is inspected after such a message is displayed on display apparatus 30, display control apparatus 50 determines that the operation corresponding to the alert image has been completed in the above-described process of step S30, and deletes the alert image in the above-described process of step S31.

The alert image created based on the travelable distance information is, for example, a message “the remaining travelable distance is 10 km.”

When fuel is supplied after such a message is displayed on display apparatus 30, display control apparatus 50 determines that the operation corresponding to the alert image has been completed in the above-described process of step S30, and deletes the alert image.

Second selector 58 may be configured as follows.

Second selector 58 may be configured such that when the line-of-sight information is not outputted, second selector 58 selects preset display apparatus 30 as a display apparatus to which the line of sight of the vehicle occupant is more likely to be directed than to the other display apparatuses.

For example, the head-up display is set beforehand as display apparatus 30 for displaying the alert image when the line-of-sight information is not outputted. Accordingly, when the line-of-sight information is not outputted, the alert image can be automatically displayed on the head-up display.

With this configuration, even when the line-of-sight information is not outputted, the alert image can be displayed on display apparatus 30 set in advance as display apparatus to which the line of sight of the vehicle occupant is more likely to be directed. It is thus possible to enhance the safety of driving.

Image information output 56 may be configured as follows.

Image information output 56 may be configured such that, when second selector 58 selects display apparatus 30 to which the line of sight of the vehicle occupant is more likely to be directed than to other display apparatuses 30, image information output 56 generates image information prompting a shift of the line of sight from a first display apparatus among the plurality of display apparatuses 30 which is not selected by second selector 58 to a second display apparatus among the plurality of display apparatuses 30 which is selected by second selector 58, and outputs the image information to the first display apparatus.

In this case, for example, when the line-of-sight information is not outputted, image information output 56 generates a message “see the head-up display.”

Then, image information output 56 displays the message on the center display and displays the alert image on the head-up display.

As described above, by displaying the message “see the head-up display” on the center display, the message displayed on the center display allows the driver to notice the alert image displayed on the head-up display, even when the line of sight cannot be detected when the driver directs the line of sight to the center display. Thus, the driver can quickly direct the line of sight to the head-up display.

Therefore, an action corresponding to the alert image can be taken quickly, and the safety of the driving can be further enhanced.

Note that second selector 58 may be configured to select, as display apparatus 30 to which the line of sight of the vehicle occupant is more likely to be directed than to other display apparatuses 30, a terminal apparatus that is portable by the vehicle occupant.

For example, after the terminal apparatus such as a smartphone and the in-vehicle devices mounted on vehicle 200 perform short-range wireless communication with each other by using Bluetooth (registered trademark) or the like and pairing is completed, and when the terminal apparatus is selected by second selector 58, image information output 56 transmits an alert image to the terminal apparatus selected by second selector 58. Thus, it is possible to display the alert image on the terminal apparatus also when the terminal apparatus is used as a navigation apparatus.

Note that, display control apparatus 50 may be configured to determine that the driver has been ignoring the alert image or does not need the operation corresponding to the alert image, and delete the alert image on display apparatus 30, for example, when the operation is not completed after the alert image is displayed for a certain period of time.

After deletion of the alert image, only the original image is displayed on display apparatus 30. It is thus becomes easier for the driver to recognize the original image, and thus, the safety of driving is further enhanced.

Note that display control apparatus 50 may locate the position of an object such as a motorcycle by using information obtained from a sensor that detects an object in the surrounding area of the vehicle, and display an alert image on display apparatus 30 which is disposed between the position and the driver.

For example, when a motorcycle approaching vehicle 200 from the left front of vehicle 200 is detected in vehicle 200 traveling toward an intersection, display control apparatus 50 causes a message such as “risk of collision” to blink on the center display located in the left front of the driver.

Accordingly, it is possible to notify the driver of a situation in which an object may collide with vehicle 200. At this time, display control apparatus 50 may simultaneously output voice guidance that prompts attention. Accordingly, the driver can take the collision avoidance action such as sudden braking, and thus the safety of driving can be further enhanced.

Note that, for example, the following aspects are also understood to fall within the technical scope of the present disclosure.
(1) A display control apparatus includes: a first selector that, when line-of-sight information indicating a direction in which a line of sight of an occupant of a vehicle is directed is outputted, selects one of a plurality of display apparatuses as a display apparatus for displaying the information provided to the occupant of the vehicle, the plurality of display apparatuses being configured to display the information, the one display apparatus existing in the direction in which the line of sight is directed; and a second selector that, when the line-of-sight information is not outputted, selects, as the display apparatus for displaying the information, one of the plurality of display apparatuses to which the line of sight of the occupant is more likely to be directed than to other display apparatuses.
(2) Based on cumulative time when the line of sight is directed to the display apparatus selected by the first selector, the second selector selects, as the display apparatus for displaying the information, the display apparatus to which the line of sight of the occupant is more likely to be directed.
(3) Based on a number of times the line of sight is directed to the display apparatus selected by the first selector, the second selector selects, as the display apparatus for displaying the information, the display apparatus to which the line of sight of the occupant is more likely to be directed.
(4) The second selector selects, as the display apparatus for displaying the information, one of a plurality of the display apparatuses selected by the first selector, the one display apparatus being a display apparatus to which the line of sight has been directed at latest time.
(5) Based on cumulative time when the information is displayed on the display apparatus selected by the first selector, the second selector selects the display apparatus for displaying the information.
(6) Based on a number of times the information is displayed on the display apparatus selected by the first selector, the second selector selects the display apparatus for displaying the information.
(7) The second selector selects, as the display apparatus for displaying the information, one of a plurality of the display apparatuses selected by the first selector, the one display apparatus being a display apparatus on which an alert image has been displayed at latest time.
(8) The second selector selects a preset display apparatus as the display apparatus to which the line of sight of the occupant is more likely to be directed than to the other display apparatuses.
(9) The display control apparatus further includes an image information output that, when the second selector selects the display apparatus to which the line of sight of the occupant is more likely to be directed than to the other display apparatuses, generates, on a first display apparatus, image information prompting a shift of the line of sight from the first display apparatus to a second display apparatus, the first display apparatus being one of the plurality of display apparatuses which is not selected by the second selector, the second display apparatus being one of the plurality of display apparatuses which is selected by the second selector, and outputs the image information to the first display apparatus.
(10) The second selector selects a terminal apparatus as the display apparatus to which the line of sight of the occupant is more likely to be directed than to the other display apparatuses, the terminal apparatus being portable by the occupant.
(11) A display control system includes the above-described display control apparatus and the display apparatus.
(12) A display control method includes a detecting step of detecting a line of sight of an occupant of a vehicle by using an imager, a line-of-sight information outputting step of outputting line-of-sight information indicating a direction in which the line of sight is directed, a first selecting step of selecting one of a plurality of display apparatuses as a display apparatus for displaying information provided to the occupant of the vehicle, when the line-of-sight information is outputted, the plurality of display apparatuses being configured to display the information, the one display apparatus existing in the direction in which the line of sight is directed; and a second selecting step of selecting, as the display apparatus for displaying the information, one of the plurality of display apparatuses to which the line of sight of the occupant is more likely to be directed than to other display apparatuses, when the line-of-sight information is not outputted.

Various embodiments have been described with reference to the drawings hereinabove. Obviously, the present disclosure is not limited to these examples. Obviously, a person skilled in the art would arrive variations and modification examples within a scope described in the present disclosure, and it is understood that these variations and modifications are within the technical scope of the present disclosure. Moreover, any combination of features of the above-mentioned embodiments may be made without departing from the spirit of the present disclosure.

While concrete examples of the present invention have been described in detail above, those examples are mere examples and do not limit the scope of the appended claims. The techniques disclosed in the scope of the appended claims include various modifications and variations of the concrete examples exemplified in the present disclosure.

The disclosure of Japanese Patent Application No. 2020-208423, filed on Dec. 16, 2020, including the specification, drawings and abstract, is incorporated herein by reference in its entirety.

### INDUSTRIAL APPLICABILITY

One exemplary embodiment of the present disclosure is suitable for a display control apparatus and a display control system.

### REFERENCE SIGNS LIST

10 Line-of-sight detection apparatus
11 Image capturing processor
12 Image processor
13 Line-of-sight detector
14 Line-of-sight information output
20 Surrounding-area monitoring apparatus
21 Surrounding-area image capturing processor
22 Image processor
23 Object detection sensor
25 Target object detector
26 Detection information output
30 Display apparatus
31 Information input
32 Original image generator
33 Image superimposition processor
34 Image display apparatus
50 Display control apparatus
51 Information input
52 Storage unit
54 Information input
55 Alert image generator
56 Image information output
57 First selector
58 Second selector
100 Display control system
200 Vehicle
210 In-vehicle device
220 ECU
230 Information processing apparatus
230A Auxiliary storage device
230B Memory device
230C CPU
230D Interface apparatus
230E Bus line

1. A display control apparatus, comprising:
a first selector that, when line-of-sight information indicating a direction in which a line of sight of an occupant of a vehicle is directed is outputted, selects one of a plurality of display apparatuses as a display apparatus for displaying information provided to the occupant of the vehicle, the plurality of display apparatuses being configured to display the information, the one display apparatus existing in the direction in which the line of sight is directed; and
a second selector that, when the line-of-sight information is not outputted, selects, as the display apparatus for displaying the information, one of the plurality of display apparatuses to which the line of sight of the occupant is more likely to be directed than to other display apparatuses.

2. The display control apparatus according to claim 1, wherein
based on cumulative time when the line of sight is directed to the display apparatus selected by the first selector, the second selector selects, as the display apparatus for displaying the information, the display apparatus to which the line of sight of the occupant is more likely to be directed.

3. The display control apparatus according to claim 1, wherein
based on a number of times the line of sight is directed to the display apparatus selected by the first selector, the second selector selects, as the display apparatus for displaying the information, the display apparatus to which the line of sight of the occupant is more likely to be directed.

4. The display control apparatus according to claim 1, wherein
the second selector selects, as the display apparatus for displaying the information, one of a plurality of the display apparatuses selected by the first selector, the one display apparatus being a display apparatus to which the line of sight has been directed at latest time.

5. The display control apparatus according to claim 1, wherein
based on cumulative time when the information is displayed on the display apparatus selected by the first selector, the second selector selects the display apparatus for displaying the information.

6. The display control apparatus according to claim 1, wherein
based on a number of times the information is displayed on the display apparatus selected by the first selector, the second selector selects the display apparatus for displaying the information.

7. The display control apparatus according to claim 1, wherein
the second selector selects, as the display apparatus for displaying the information, one of a plurality of the display apparatuses selected by the first selector, the one display apparatus being a display apparatus on which an alert image has been displayed at latest time.

8. The display control apparatus according to claim 1, wherein
the second selector selects a preset display apparatus as the display apparatus to which the line of sight of the occupant is more likely to be directed than to the other display apparatuses.

9. The display control apparatus according to claim 1, further comprising:
an image information output that
when the second selector selects the display apparatus to which the line of sight of the occupant is more likely to be directed than to the other display apparatuses, generates image information prompting a shift of the line of sight from a first display apparatus to a second display apparatus, the first display apparatus being one of the plurality of display apparatuses which is not selected by the second selector, the second display apparatus being one of the plurality of display apparatuses which is selected by the second selector, and
outputs the image information to the first display apparatus.

10. The display control apparatus according to claim 1, wherein
the second selector selects a terminal apparatus as the display apparatus to which the line of sight of the occupant is more likely to be directed than to the other display apparatuses, the terminal apparatus being portable by the occupant.

11. The display control apparatus according to claim 1, wherein
an alert image for notifying the occupant of existence of an object detected by a detection apparatus for detecting an object existing in a surrounding area of the vehicle is displayed.

12. The display control apparatus according to claim 11, wherein
when an operation corresponding to the alert image is completed, the alert image is deleted.

13. The display control apparatus according to claim 1, wherein
the plurality of display apparatuses are a center display, an in-vehicle meter panel, and a head-up display.

14. The display control apparatus according to claim 1, wherein
the display apparatus for displaying the information displays an image in which an alert image is superimposed on an original image.

15. The display control apparatus according to claim 1, wherein
when the line-of-sight information is not outputted, a notification is given to a driver.

16. The display control apparatus according to claim 15, wherein
the notification is a voice, blinking of a lamp inside the vehicle, or a vibration of steering or a seat.

17. The display control apparatus according to claim 1, wherein
the first selector identifies a display apparatus existing at a position closest to the line of sight as a display apparatus existing in a direction in which the line of sight of a driver is directed.

18. A display control system, comprising:
a display control apparatus according to claim 1; and
a plurality of the display apparatuses.

19. A vehicle in which a display control system according to claim 11 is mounted.

20. A display control method, comprising:
a detecting step of detecting a line of sight of an occupant of a vehicle by using an imager;
a line-of-sight information outputting step of outputting line-of-sight information indicating a direction in which the line of sight is directed;
a first selecting step of selecting one of a plurality of display apparatuses as a display apparatus for displaying information provided to the occupant of the vehicle, when the line-of-sight information is outputted, the plurality of display apparatuses being configured to display the information, the one display apparatus existing in the direction in which the line of sight is directed; and
a second selecting step of selecting, as the display apparatus for displaying the information, one of the plurality of display apparatuses to which the line of sight of the occupant is more likely to be directed than to other display apparatuses, when the line-of-sight information is not outputted.
